(19) United States
(12) Patent Application Publication
(10) Pub. No.: US 2025/0100835 A1
(43) Pub. Date: Mar. 27, 2025

(54) METHOD FOR PRODUCING A STACK FORMED FROM MULTIPLE ELECTROCHEMICAL CELLS AND DEVICE FOR PRODUCING SUCH A STACK

(71) Applicant: AUDI AG, Ingolstadt (DE)

(72) Inventors: Uwe BAUCH, Denkendorf (DE); Jan RICHNOW, Ingolstadt (DE); Rene SCHEIMER, Riedenburg (DE)

(21) Appl. No.: 18/290,736

(22) PCT Filed: Jul. 20, 2022
(86) PCT No.: PCT/EP2022/070282

§ 371 Date: Jan. 19, 2024

(30) Foreign Application Priority Data
Jul. 22, 2021 (DE) 102021118976.4

(51) Int. Cl. B65H 31/28; B65H 31/38; C25B 9/23; H01M 8/10; H01M 8/1004

(52) U.S. Cl. CPC B65H 31/28; B65H 31/38; C25B 9/23; H01M 8/1004; B65H 2404/10; B65H 2701/19; H01M 2008/1095

(57) ABSTRACT

The disclosure relates to a method for producing a stack formed from multiple electrochemical cells, each of the electrochemical cells having a plurality of constituent components including at least one membrane component and a bipolar plate. The method includes orienting each constituent component of the constituent components on an edge of the constituent component, forming aligned components by feeding each constituent component of the constituent components oriented on the edge of the constituent component to a shaking boom, and forming the stack from the aligned components. The disclosure furthermore relates to a device for producing such a stack.

### BACKGROUND

### Technical Field

The disclosure relates to a method for producing a stack formed from multiple electrochemical cells, each of the electrochemical cells having a plurality of constituent components including at least one membrane component and a bipolar plate, involving:
orienting each constituent component of the components on an edge of the constituent component,
forming aligned components by feeding each constituent component of the constituent components oriented on the edge of the constituent component to a shaking boom,
forming the stack from the aligned components.

The disclosure furthermore relates to a device for producing such a stack.

### Description of the Related Art

Fuel cells serve for providing electric energy by an electrochemical reactions, where multiple fuel cells can be hooked up in series and assembled to form a stack. In the case of electrolyzer cells, electric energy is used for electrolysis, and once again a stack can be formed in order to increase the power. A membrane component, especially a membrane electrode assembly, being one of the components of the stack, comprises an anode, a cathode, and a proton-conducting membrane separating the anode from the cathode. Furthermore, on both sides of each membrane in the stack there are provided bipolar plates as an additional component to supply the reactants and optionally a coolant.

When forming the stack, that is, during its production, positional accuracy and speed are important for quality and cost, but good positional accuracy and high speed as goals are in conflict with each other and generally only one goal can be improved, at the expense of the other goal.

Electrochemical cells are often assembled into stacks by using grippers in a “pick-and-place” method, the components being positioned by way of static reference points, such as in the form of a workpiece holder. Improved positional accuracy can also be achieved by using a laser, for example, to connect the components of the membrane electrode assembly and the bipolar plate to form the unit cells, which are then stacked further to produce the stack. The “pick-and-place” method as well as mechanical connection are cost intensive and do not attain the necessary speed for mass production, and the positional accuracy is also inadequate.

In DE 10 2018 116 057 A1 an assembly layout is described for the assembly of a fuel cell stack, where the components of the fuel cell stack arranged in alternation on a conveyor belt are taken by the conveyor belt along a chute to a height-adjustable stack receiver, and a gas supply device is present in the region of the chute to create a gas cushion. The chute can be formed by powered conveyor belts. The stack receiver has a shaking function for a more secure and precise alignment. Shaking devices in stacking devices for printing machinery for the stacking of sheets of paper are known from DE 29 42 855 A1 and DE 10 2019 206 610 B3.

### BRIEF SUMMARY

Embodiments of the disclosure provide a method with which capital investments and manufacturing costs can be lowered for the production of a stack. Embodiments of the disclosure also provide a device to carry out the method.

The method of the disclosure affords the advantage that the individual components are placed on their edges and thus only one line of contact is present at the bottom, i.e., no two-dimensional contact with increased friction to make the positioning and alignment more difficult. Unlike the prior art, the stack is not layered upward with constantly increasing weight increasing the force on the contact surface. Instead, the same conditions exist for each component during the alignment thanks to the shaking boom, regardless of the position of the component within the stack. Therefore, the stack can be formed much more quickly, and no gripper is needed, so that the costs of the stack are lowered.

For the proper formation of the stack, the components can be placed by their flat side on the upper run of a conveyor belt, in particular, the components can be arranged alternately on a first conveyor belt. Alternatively, however, it is also possible for one of the components to be placed from a first loading station on the first conveyor belt, and for the other of the components to be layered from a second loading station on the one component placed on the first conveyor belt, so that the first component and a second component layered on each other form a nonconnected unit cell.

With no further equipment expense, there is the possibility of orienting the components whereby the first components and the second components, optionally assembled as a unit cell, are oriented upon passing a deflection roller of the first conveyor belt, so these can be easily converted from their position lying flat to a vertical orientation by simply continuing the transport on the first conveyor belt, where the edge being the line of support is directed downward. Thanks to being supported on the edge, the desired position in the shaking boom can be easily produced with little resistance, and the components are then transferred from the shaking boom to a second conveyor belt.

Preferably, the shaking boom vibrates in the circumferential direction of the components at multiple shaking points on its side edges and the top edge, and the oriented component is mounted on at least two support points of the edge. The mounting on the support points instead of on the entire edge further facilitates the establishing of the position with the desired positional accuracy.

One advantageous device for producing a stack of multiple electrochemical cells, each of them formed from a membrane electrode assembly and a bipolar plate as the constituent components, is characterized in that a shaking boom is provided for receiving the components oriented to their edge, and downstream from the shaking boom is situated a second conveyor belt for transport of the stack being formed from the oriented components, wherein a first conveyor belt is provided, on the upper run of which components of the electrochemical cells can be placed by their flat side, and the shaking boom is arranged between the downstream situated deflection roller of the first conveyor belt and the upstream situated deflection roller of the second conveyor belt.

The aforementioned benefits, especially in terms of cost, also apply to a fuel cell device having a stack produced according to the aforementioned method and to a motor vehicle having such a fuel cell device, so that electric mobility can be achieved at a more favorable cost.

The features and combinations of features mentioned above in the description and the features and combinations of features mentioned below in the description of the figures and/or shown solely in the figures can be used not only in the particular indicated combination, but also in other combinations or standing alone, without leaving the scope of the disclosure. Thus, embodiments which are not shown explicitly or explained in the figures, yet which can be created and emerge from separated combinations of features from the explained embodiments should be viewed as also being disclosed and encompassed by the disclosure.

### BRIEF DESCRIPTION OF THE SEVERAL VIEWS OF THE DRAWINGS

Further benefits, features and details of the disclosure will emerge from the claims, the following description of advantageous embodiments, and the drawings.

FIG. 1 shows a schematic representation of a device for producing a stack 2 of electrochemical cells,

FIG. 2 shows a schematic representation of the effect of shaking of the der components set up on their edges 11, and

FIG. 3 shows a device known from the prior art for producing a stack 2 of electrochemical cells with a gripper 4 to perform a “pick-and-place” method.

### DETAILED DESCRIPTION

In order to explain the disclosure, we shall refer in the following to the example of fuel cells 1 and a fuel cell stack formed from them, although this also holds accordingly for other electrochemical cells and their assembly to form a stack 2 for boosted power. As an example of another electrochemical cell, one can mention an electrolyzer.

A stack 2 of fuel cells 1 consists of a plurality of fuel cells 1 hooked up in series and arranged between two end plates, each of the fuel cells 1 having an anode and a cathode as well as a proton-conducting membrane separating the anode from the cathode. The membrane is made from an ionomer. A catalyst can be additionally mixed in with the anodes and/or the cathodes, the membranes being preferably coated on their first side and/or on their second side with a catalyst layer of a precious metal or mixtures containing precious metals such as platinum, palladium, ruthenium or the like, which serve as reaction accelerators during the reaction of the particular fuel cell 1. The anode and the cathode as well as the membrane form a membrane electrode assembly 10. A plurality of membrane components can also be arranged in each fuel cell.

Through polar plates, which can also be designed as bipolar plates 3 inside the stack 2, fuel (such as hydrogen) can be supplied to the anodes and cathode gas (such as oxygen or air containing oxygen) to the cathodes, while gas diffusion layers are used for an equal distribution of the reactants. In a polymer electrolyte membrane fuel cell (PEM fuel cell), fuel or fuel molecules are split into protons and electrons at the anode. The membrane lets through the protons (for example, H⁺), but it is not permeable to the electrons (e⁻). At the anode the following reaction occurs: 2H₂→4H⁺+4e⁻ (oxidation/electron surrender). While the protons pass through the membrane to the cathode, the electrons are taken by an external circuit to the cathode or to an energy accumulator. The following reaction occurs at the cathode side: O₂+4H⁺+4e⁻→2H₂O (reduction/electron uptake).

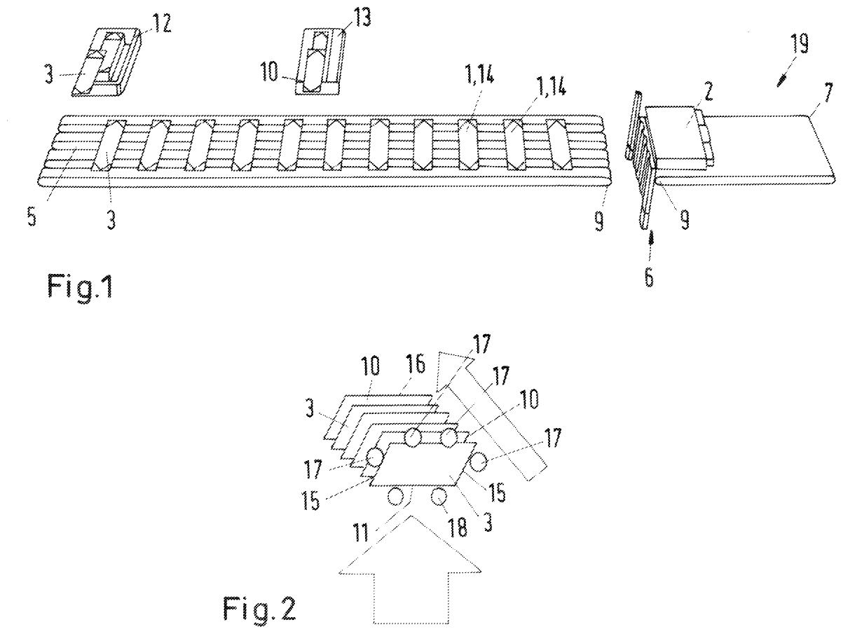

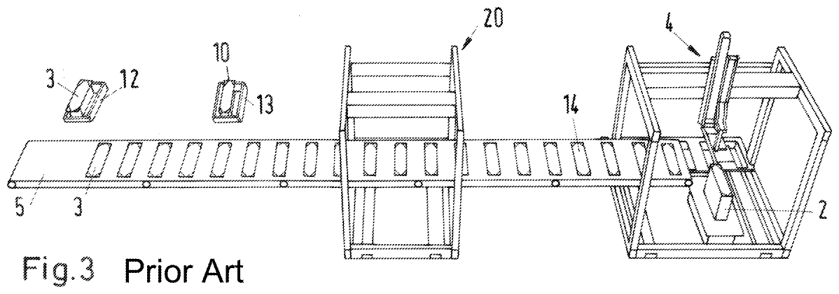

FIG. 1 shows a device 19 for production of a stack 2 formed from multiple electrochemical cells, which unlike the device known from the prior art and shown in FIG. 3 works without a gripper 4 for a “pick-and-place” method and with a station for a laser 20, building up the stack 2 vertically. In this device, it is also necessary to secure the bipolar plates 3 and the membrane electrode assembly 10 by way of a laser 20 in a downstream station.

The device 19 per FIG. 1 comprises, in the exemplary embodiment shown, a first conveyor belt 5, a shaking boom 6 and a second conveyor belt 7, the shaking boom 6 being arranged between the downstream situated deflection roller 9 of the first conveyor belt 5 and the upstream situated deflection roller 9 of the second conveyor belt 7. With this device 19, it is possible to produce a stack 2 formed from multiple electrochemical cells, each of them formed from at least one membrane component 10 and a bipolar plate 3 as the constituent components, by a method involving:
orienting each constituent component of the constituent components on an edge 11 of the constituent component,
forming aligned components by feeding each constituent component of the components oriented on the edge 11 of the constituent component to a shaking boom 6, and
forming the stack 2 from the aligned components.

The components here, namely the membrane electrode assemblies 10 and the bipolar plate 3, are placed by their flat side on the upper run of the first conveyor belt 5 and are arranged, especially in alternating fashion, on the first conveyor belt 5. However, it is also possible for the feeding to the shaking boom 6 to occur in alternation, as long as it is assured that the components are oriented. For example, the components can be passed on to the shaking boom 6 with a suction head, a loading shaft, or a gripper. FIG. 1 shows an embodiment in which one of the components is placed from a first loading station 12 on the first conveyor belt 5 and the other of the components is layered from a second loading station 13 onto the component placed on the first conveyor belt 5. In this way, unit cells 14 are formed, where the components need not be connected, although neither is that ruled out. Thus, the first component and second component layered on each other form an unconnected unit cell 14, from this the stack 2 is then built up by feeding the unit cells 14 to the shaking boom 6.

It is possible for the first components and the second components, individually or also as a unit cell 14, to be oriented simply upon passing the deflection roller 9 of the first conveyor belt 5. For this, suction openings or alternatively or additionally guide rods can be associated with the first conveyor belt 5 for fixing the position of the components. It is also possible for the second conveyor belt 7 to be lower in position, especially by the width of the components, than the first conveyor belt 5, in order to transfer the components or unit cells 14 oriented on their edges 11 upon passing the deflection roller 9 to the shaking boom 6 and to the second conveyor belt 7.

FIG. 2 shows that the shaking boom 6 vibrates in the circumferential direction of the components at multiple shaking points 17 on its side edges 15 and the top edge 16, while the oriented component is mounted on at least two support points 18 of the edge 11.

In this way, the stack 2 is successively built up on the second conveyor belt 7, the unit cells 14 or the components being oriented in correct position. The stack 2 can then be transported away with the second conveyor belt 7.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for producing a stack formed from multiple electrochemical cells, each of the electrochemical cells having a plurality of constituent components including at least one membrane component and a bipolar plate, the method comprising:
orienting each constituent component of the constituent components on an edge of the constituent component;
forming aligned components by feeding each constituent component of the constituent components oriented on the edge of the constituent component to a shaking boom; and
forming the stack from the aligned components.

2. The method according to claim 1, further comprising:
placing a flat side of each constituent component of the constituent components on a first conveyor belt.

3. The method according to claim 2, wherein the placing includes:
placing, from a first loading station, a first one of the constituent components of one of the electrochemical cells on the first conveyor belt; and
layering, from a second loading station, a second one of the constituent components of the one of the electrochemical cells on the first one of the constituent components of the one of the electrochemical cells placed on the first conveyor belt.

4. The method according to claim 3, wherein the first one of the constituent components of the one of the electrochemical cells layered on the second one of the constituent component of the one of the electrochemical cells form a nonconnected unit cell.

5. The method according to claim 2, further comprising:
orienting the constituent components by passing the constituent components past a deflection roller of the first conveyor belt.

6. The method according to claim 1, further comprising:
passing the constituent components from the shaking boom to a second conveyor belt.

7. The method according to claim 1, further comprising:
vibrating the shaking boom in a circumferential direction of the constituent components at multiple shaking points on side edges and a top edge of the shaking boom.

8. The method according to claim 1, further comprising:
mounting each constituent component of the constituent components on at least two support points of the edge of the constituent component.

9. A device for producing a stack formed from multiple electrochemical cells, each of the electrochemical cells having a plurality of constituent components including at least one membrane component and a bipolar plate, the device comprising:
a shaking boom that, in operation, receives each constituent component of the constituent components oriented on an edge of the constituent component; and
a second conveyor belt downstream from the shaking boom, wherein the second conveyor belt, in operation, transports the stack formed from each constituent component of the constituent components oriented on the edge of the constituent component.

10. The device according to claim 9, further comprising:
a first conveyor belt that, in operation, includes each constituent component of the constituent components of the electrochemical cells placed on a flat side of the constituent component, and
wherein the shaking boom is between a downstream situated deflection roller of the first conveyor belt and an upstream situated deflection roller of the second conveyor belt.
